(19) United States
(12) Patent Application Publication
(10) Pub. No.: US 2024/0393544 A1
(43) Pub. Date: Nov. 28, 2024

(54) PHOTOELECTRIC COMPOSITE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroyoshi MAESOBA, Osaka (JP); Katsuya IKUTA, Osaka (JP); Hidetoshi ISHIDA, Osaka (JP)

(21) Appl. No.: 18/696,354

(22) PCT Filed: Oct. 4, 2022
(86) PCT No.: PCT/JP2022/037079

§ 371 Date: Mar. 27, 2024

(30) Foreign Application Priority Data
Oct. 5, 2021 (JP) 2021-163993

(51) Int. Cl. G02B 6/38

(52) U.S. Cl. CPC G02B 6/3817; G02B 6/3869

(57) ABSTRACT

It is aimed to provide an easily assemblable photoelectric composite connector. A photoelectric composite connector 1 includes at least one optical ferrule 5 to be coupled to an optical fiber 81 of an optical cable 8, at least one electrical connection terminal 7 to be coupled to a wire 9, a sub-housing 3 for accommodating the at least one optical ferrule 5, a spring member 6 for biasing the optical ferrule 5 toward a tip side by being accommodated into the sub-housing 3, and a main housing 2 capable of collectively accommodating the sub-housing 3 and the electrical connection terminal 7. The sub-housing 3 constitutes an optical sub-connector S by accommodating the optical ferrule 5 and the spring member 6. The main housing 2 accommodates and fixes the optical sub-connector S and the electrical connection terminal 7.

### TECHNICAL FIELD

The present disclosure relates to a photoelectric composite connector.

### BACKGROUND

An optical cable using an optical fiber is widely used in information communication for household, industry and the like since high-speed communication of a large amount of information is possible. Further, various electronic devices such as a car navigation system are equipped in an automotive vehicle. Optical communication using an optical cable has begun to be used also for communication in those devices. Particularly, the speed up of communication has accelerated in the field of automotive vehicles in recent years. There are many problems in carrying out high-speed communication exceeding several Gbps by an electrical cable. With the speed up of communication, optical cables capable of dealing with high-speed communication are becoming more and more important in in-vehicle communication devices. Particularly, an optical cable provided with an optical fiber made of glass can be suitably used in high-speed communication.

On the other hand, an optical cable is not suitable for supplying an energy necessary to operate a communication device, and a wire provided with a metal wire is also used together with the optical cable. Accordingly, to enable an optical cable and a wire to be easily connected to a device such as a communication device, connectors capable of collectively connecting an optical cable and a wire to a device have been and are being developed. Photoelectric composite connectors of that type are disclosed in Patent Document 1 and the like and some have been put to practical use.

### PRIOR ART DOCUMENT

### Patent Document

Patent Document 1: International Publication WO 2007/088863

### SUMMARY OF THE INVENTION

### Problems to be Solved

As described above, photoelectric composite connectors have been and are being developed as a means for collectively connecting an optical cable and a wire to a device such as a communication device, but the composite connectors of that type tend to be difficult to manufacture as compared to optical connectors for connecting only an optical cable and electrical connectors for connecting only a wire. One of reasons for that is that a manufacturing process and a manufacturing facility are normally totally different for optical connectors and for electrical connectors and it is difficult to manufacture a composite connector integrally provided with a connecting portion for an optical cable and a connecting portion for a wire in the same manufacturing line. Particularly, difficulties tend to occur in precisely aligning an optical communication member such as an optical ferrule at a predetermined position and assembling this together with a wire in a connector housing. Further, with the speed up of communication in automotive vehicles, conventionally used plastic optical fibers (POFs) have been replaced by glass optical fibers (AGFs) in recent years. Since AGFs have a smaller diameter than POFs, an optical communication member for AGF is smaller in size than an optical communication member for POF and it is particularly difficult to precisely arrange the optical communication member for AGF in a connector housing. Moreover, the optical communication member for AGF is required to be arranged with high accuracy to obtain high communication performance.

In view of the above, it is aimed to provide an easily assemblable photoelectric composite connector.

### Means to Solve the Problem

The present disclosure is directed to a photoelectric composite connector with at least one optical ferrule to be coupled to an optical fiber of an optical cable, at least one electrical connection terminal to be coupled to a wire, a sub-housing for accommodating the at least one optical ferrule, a spring member for biasing the optical ferrule toward a tip side by being accommodated into the sub-housing, and a main housing capable of collectively accommodating the sub-housing and the electrical connection terminal, the sub-housing constituting an optical sub-connector by accommodating the optical ferrule and the spring member, and the main housing accommodating and fixing the optical sub-connector and the electrical connection terminal.

### Effect of the Invention

A photoelectric composite connector according to the present disclosure is an easily assemblable photoelectric composite connector.

### BRIEF DESCRIPTION OF THE DRAWINGS

FIGS. 1A and 1B are perspective views showing an entire photoelectric composite connector according to one embodiment of a present disclosure, wherein FIG. 1A shows a state when viewed from front and FIG. 1B shows a state when viewed from behind.

FIG. 2 is an exploded perspective view showing the photoelectric composite connector.

FIGS. 3A and 3B are views showing an optical sub-connector included in the photoelectric composite connector, wherein FIG. 3A is a perspective view and FIG. 3B is a partial section along A-A in FIG. 3A.

FIGS. 4A and 4B are side views showing estimated simulation results of a deformation amount of a sub-housing in the optical sub-connector, wherein FIG. 4A shows a form including an engagement structure by a rib portion shown in FIG. 3A and FIG. 4B shows a form not including the engagement structure by the rib portion.

### DETAILED DESCRIPTION TO EXECUTE THE INVENTION

### Description of Embodiments of Present Disclosure

First, embodiments of the present disclosure are listed and described.

The photoelectric composite connector of the present disclosure is provided with at least one optical ferrule to be coupled to an optical fiber of an optical cable, at least one electrical connection terminal to be coupled to a wire, a sub-housing for accommodating the at least one optical ferrule, a spring member for biasing the optical ferrule toward a tip side by being accommodated into the sub-housing, and a main housing capable of collectively accommodating the sub-housing and the electrical connection terminal, the sub-housing constituting an optical sub-connector by accommodating the optical ferrule and the spring member, and the main housing accommodating and fixing the optical sub-connector and the electrical connection terminal.

In the above photoelectric composite connector, the optical ferrule is not directly accommodated into the main housing accommodating the electrical connection terminal, but the optical ferrule is accommodated into the sub-housing separately from the electrical connection terminal to configure the optical sub-connector and the optical sub-connector is accommodated into the main housing. The optical sub-connector can be manufactured utilizing conventional manufacturing process and manufacturing facility for optical connectors, and a step of assembling the completed optical sub-connector into the main housing together with the electrical connection terminal can be easily performed as compared to a step of directly assembling the optical ferrule into the housing together with the electrical connection terminal. Further, by providing the spring member for biasing the optical ferrule toward the tip side inside the sub-housing in the optical sub-connector, the optical ferrule is easily held at a proper position and in a proper posture by being pressed toward the tip side in the sub-housing and the manufacturability of the optical sub-connector is enhanced. An effect of improving manufacturability by the presence of the spring member is particularly notable in the case of using an optical ferrule having a small area of a tip surface to be coupled to a thin optical fiber such as an AGF.

Here, the spring member may press the tip surface of the optical ferrule constituting the optical sub-connector toward a tip surface of an optical ferrule of a mating connector when the photoelectric composite connector is connected to the mating connector including the optical ferrule. Then, the tip surfaces of the optical ferrules are butted against each other by a biasing force of the spring member and that butted state is easily maintained. As a result, a reflection loss of an optical signal between the optical ferrules is suppressed and good optical connection is obtained. This effect is also particularly notable in the case of using an optical ferrule having a small area of a tip surface to be coupled to a thin optical fiber such as an AGF.

Further, the sub-housing may be composed of two divided members including an upper member and a lower member divided in a vertical direction orthogonal to a front-rear direction along an axis of the accommodated optical ferrule, the sub-housing may include a cable holding portion for sandwiching and fixing a cable fixing member mounted on the optical cable coupled to the optical ferrule between the two divided members in a rear end part, and the optical ferrule coupled to the optical cable may be accommodated in the sub-housing with the optical ferrule biased forward by the spring member and the cable fixing member sandwiched by the cable holding portion in the optical sub-connector. Then, since the sub-housing is composed of the two divided members, a step of arranging the optical ferrule and the spring member in the sub-housing to fabricate the optical sub-connector can be easily performed. Further, by holding the optical ferrule in a state biased forward by the spring member and sandwiching and holding the cable fixing member mounted on the optical cable between the two divided members in the sub-housing, the optical ferrule can be held at the proper position in the sub-housing and can be stably held arranged even if the optical cable receives a tensile force. Thus, the fabrication of the optical sub-connector, the assembly workability of the optical sub-connector into the main housing and convenience during the use of the manufactured photoelectric composite connector are enhanced.

In this case, the upper and lower members may be coupled with two end edges including a lower end edge along the front-rear direction of the upper member and an upper end edge along the front-rear direction of the lower member butted against each other in the sub-housing, one of the two end edges may include a rib portion projecting toward the other end edge in an intermediate part in the front-rear direction, and the other end edge may include a rib accommodating portion in an intermediate part in the front-rear direction, the rib accommodating portion being in the form of a recess for accommodating the rib portion and engaging the rib portion. Then, in the sub-housing, the upper and lower members can be firmly coupled by the engagement of the rib portion and the rib accommodating portion. Further, even if a restoring force of the spring member biasing the optical ferrule by being accommodated into the sub-housing is transmitted to the sub-housing, the firmly coupled state of the upper and lower members is stably maintained and the occurrence of deflection and deformation of the sub-housing in the front-rear direction is suppressed by distributing the force transmitted to the sub-housing.

Further, an engaging portion obtained by engaging the rib portion and the rib accommodating portion may not protrude outward about a center axis along the front-rear direction as compared to other parts with the upper and lower members coupled to each other in the sub-housing. Then, the enlargement of the optical sub-connector can be suppressed even if the rib portion is provided and the size of the entire photoelectric composite connector can also be suppressed. Further, since the rib portion hardly hinders an assembly operation in assembling the optical sub-connector into the main housing, assembly workability is enhanced.

An outer peripheral surface of the sub-housing may be flush with an engaging portion obtained by engaging the rib portion and the rib accommodating portion and locations before and after the engaging portion with the upper and lower members coupled to each other. Then, a particularly high effect of suppressing the enlargement of the optical sub-connector and improving assembly workability is obtained.

Alternatively, the sub-housing may be composed of two divided members including a front member and a rear member divided in the front-rear direction along the axis of the accommodated optical ferrule, the rear member may include a cable holding portion for fixing and holding a cable fixing member mounted on the optical cable coupled to the optical ferrule in a rear end part, and the optical ferrule coupled to the optical cable may be accommodated in the sub-housing with the optical ferrule biased forward by the spring member and the cable fixing member fixed by the cable holding portion in the optical sub-connector. Also in this case, the step of fabricating the optical sub-connector can be easily performed since the sub-housing is composed of the two divided members. Further, the optical ferrule can be held at the proper position in the sub-housing by biasing the optical ferrule forward by the spring member and fixing the cable fixing member by the cable holding portion, and the optical ferrule can be stably held arranged even if the optical cable receives a tensile force. Thus, the fabrication of the optical sub-connector, the assembly workability of the optical sub-connector into the main housing and convenience during the use of the manufactured photoelectric composite connector are enhanced.

### Details of Embodiment of Present Disclosure

Hereinafter, a photoelectric composite connector according to an embodiment of the present disclosure is described in detail using the drawings. In this specification, terms indicating the shapes and arrangements of members such as a “circular shape,” a “rectangular tube shape,” a “center,” “parallel” and “flush” include not only geometrically strict concepts, but also errors within a generally allowable range as the photoelectric composite connector.

### Summary of Structure of Optical-Electrical Composite Connector

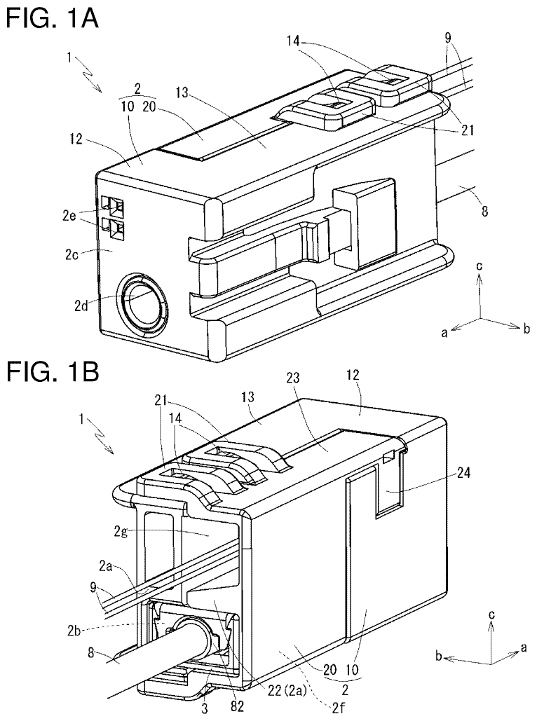

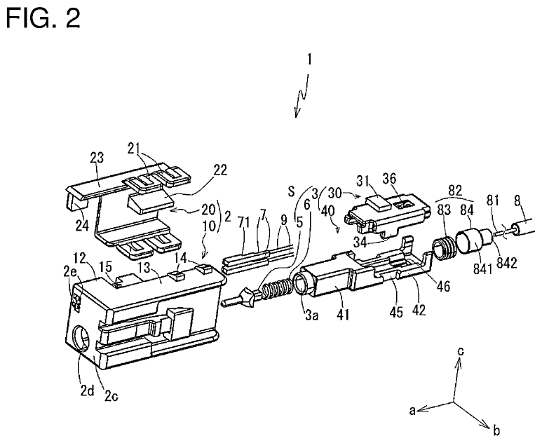

FIGS. 1A, 1B and 2 are perspective views and an exploded perspective view respectively showing a photoelectric composite connector (hereinafter, may be merely referred to as a composite connector) 1 according to one embodiment of the present disclosure. The composite connector 1 according to this embodiment is connected to the tip of an assembly of an optical cable 8 and wires 9 to simultaneously perform optical connection for optical communication and electrical connection for conduction. The composite connector 1 according to this embodiment is not fixed to a member such as a communication device or a printed circuit board, but is configured as a cable connector detachably attachable to a mating connector together with the optical cable 8 and the wires 9.

The composite connector 1 according to this embodiment is provided with at least one optical ferrule 5 as an optical communication part and at least one electrical connection terminal 7 as an electrical connection part. A sub-housing 3 is provided as an accommodating member for accommodating the optical ferrule 5. A spring member 6 is accommodated together with the optical ferrule 5 into the sub-housing 3, thereby configuring an optical sub-connector S. Further, the composite connector 1 is provided with a main housing 2 capable of collectively accommodating the sub-housing 3 and the electrical connection terminals 7, and the optical sub-connector S and the electrical connection terminals 7 are accommodated and fixed in the main housing 2.

In this specification, a front-rear direction (a direction) is so specified that a connection direction of the photoelectric composite connector 1 to the mating connector is a forward direction and a connection direction of the optical cable 8 and the wires 9 is a rearward direction. That is, axial directions of the optical ferrule 5 and the electrical connection terminals 7 are the front-rear direction, and tip sides of the optical ferrule 5 and the electrical connection terminals 7 are front sides. A direction, which is orthogonal to the front-rear direction and in which a pair of the electrical connection terminals 7 and the sub-housing 3 accommodating the optical ferrule 5 are arranged in parallel, is a vertical direction (c direction), and a direction orthogonal to the front-rear direction and vertical direction is a width direction (b direction).

The optical ferrule 5 is constituted by a known optical fiber ferrule and an optical cable 8 is fixed thereto. Here, the types of the optical cable 8 and the optical ferrule 5 are not particularly limited, but a cable provided with a glass optical fiber (AGF) is preferably used as the optical cable 8 from the perspective of application to high-speed communication. Generally widely used AGFs have a cladding diameter of 125 μm and, even in the case of a multi-mode type, have a small core diameter of 100 μm or less, and compatible optical ferrules also have a small tip surface area. The optical cable 8 is coupled and fixed to the optical ferrule 5 with an optical fiber 81 exposed in a tip part arranged to be flush with the tip surface of the optical ferrule 5.

Further, a cable fixing member 82 composed of a stop ring 83 and a crimp ring 84 is mounted on the tip part of the optical cable 8 coupled to the optical ferrule 5 by being fixed to the outer periphery of the optical cable 8. The stop ring 83 is a ring-shaped member. The crimp ring 84 is a hollow cylindrical member provided with a step and includes a large-diameter portion 841 at the front and a small-diameter portion 842 continuous with the large-diameter portion 841 and having a smaller diameter than the large-diameter portion 841 at the back. A reinforced strand (not shown) pulled out from the optical cable 8 is sandwiched between the stop ring 83 and the large-diameter portion 841 of the crimp ring 84 arranged on the outer periphery of the stop ring 83, and the crimp ring 84 is fixed on a sheath of the optical cable 8 at the small-diameter portion 842.

In the shown embodiment, one optical ferrule 5 is included in the composite connector 1, but a plurality of optical ferrules 5 may be included. If the plurality of optical ferrules 5 are provided, each optical ferrule 5 is individually coupled to the optical fiber 81. If the plurality of optical ferrules 5 are included in the composite connector 1, the plurality of optical ferrules 5 may be respectively accommodated into the common sub-housing 3 together with the corresponding spring members 6 to configure the optical sub-connector S. Further, a plurality of the optical sub-connectors S each configured by accommodating one or more pairs of the optical ferrule 5 and the spring member 6 into the sub-housing 3 may be accommodated into the main housing 2.

The electrical connection terminal 7 is configured as an electrical connection terminal for known insulated wire. The electrical connection terminal 7 is fixed to a tip part of the insulated wire 9 and electrically connected to a wire conductor exposed on a tip side of the insulated wire 9. The type of the electrical connection terminal 7 is not particularly limited, but a fitting-type female terminal can be suitably applied as such. Although a pair of (two) electrical connection terminals 7 are included in the composite connector 1 in the shown embodiment, the number of the electrical connection terminals 7 is not particularly limited if at least one electrical connection terminal 7 is included.

The optical ferrule 5 coupled to the optical cable 8 is accommodated into the sub-housing 3 together with the spring member 6 to configure the optical sub-connector S. The structures of the sub-housing 3 and the optical sub-connector S are described in detail later. In the shown embodiment, one optical ferrule 5 is arranged on a center axis of the sub-housing 3. A connection sub-opening 3a is formed as an opening facing the tip surface of the optical ferrule 5 and enabling the entrance of an optical connecting portion of the mating connector including an optical ferrule at the front of the sub-housing 3.

The main housing 2 has a front end surface 2c at the front and is configured as a resin member substantially in the form of a rectangular tube open rearward. The main housing 2 is formed into a rectangular tube shape by coupling two members including a housing body portion 10 and a retainer member 20. The housing body portion 10 includes a tubular portion 12 at the front and an open portion 13 integrated with the tubular portion 12 and open on one side in the width direction (−b direction) behind the tubular portion 12. The retainer member 20 is shaped to cover the open portion 13 of the housing body portion 10 from outside in the width direction (−b direction), and the main housing 2 substantially in the form of a rectangular tube is configured by coupling the retainer member 20 to the open portion 13 of the housing body portion 10.

The retainer member 20 is provided with looped locking tabs 21 on upper and lower wall surfaces. The housing body portion 10 is provided with locking projections 14 lockable to the locking tabs 21 at positions corresponding to the locking tabs 21 when the retainer member 20 is coupled. The housing body portion 10 and the retainer member 20 can be coupled by covering the open portion 13 of the housing body portion 10 by the retainer member 20 and locking the loop structures of the locking tabs 21 to the locking projections 14. Locking structures between the locking tabs 21 and the locking projections 14 cannot be easily released once being locked. Further, the main housing 2 may be auxiliarily provided with members for holding the housing body portion 10 and the retainer member 20 in the coupled state, besides the pairs of the locking tab 21 and the locking projection 14. For example, claws 15 may be provided on the outer wall surface of the housing body portion 10 in front of the locking tabs 21 and the locking projections 14 and claws (not shown) to be engaged with the claws 15 may be provided at corresponding positions of the retainer member 20.

An internal space of the main housing 2 constituted by the housing body portion 10 and the retainer member 20 is partitioned in the vertical direction into a sub-connector accommodation space 2f below and an upper space including a terminal accommodation space 2g by a partition wall 2a. The sub-housing 3 configuring the optical sub-connector S by accommodating the optical ferrule 5 and the like is accommodated into the sub-connector accommodation space 2f, and the electrical connection terminals 7 connected to the wires 9 are accommodated into the terminal accommodation space 2g. The electrical connection terminals 7 and the optical ferrule 5 accommodated in the sub-housing 3 are arranged with axial directions thereof oriented in the front-rear direction in the main housing 2. The front end surface 2c of the main housing 2 is formed with an optical connection opening 2d at a position in front of the connection sub-opening 3a of the sub-housing 3, and the optical connecting portion of the mating connector including the optical ferrule can enter the sub-housing 3 through the optical connection opening 2d and the connection sub-opening 3a. Further, electrical connection openings 2e are formed at positions of the front end surface 2c in front of the respective electrical connection terminals 7, and electrical connecting portions of the mating connector including electrical connection terminals can enter the terminal accommodation space 2g.

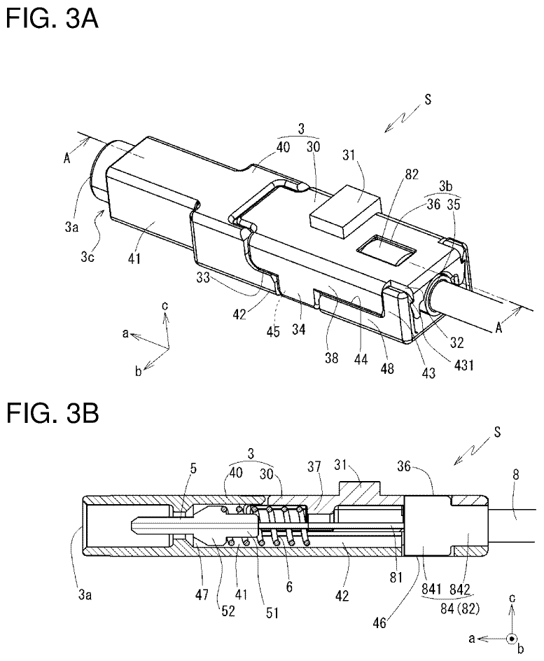

In the main housing 2, an opening 2b on the rear end of the sub-connector accommodation space 2f is sized and shaped such that the sub-housing 3 can be accommodated without rattling. Further, the retainer member 20 is provided with a locking inner projection 22 constituting a part of the partition wall 2a by projecting inward (+b direction) from an inner wall surface on a lateral side (−b direction), and this locking inner projection 22 is locked to a locking projecting portion 31 provided on the outer wall surface of the sub-housing 3 accommodated in the sub-connector accommodation space 2f in the front-rear direction. Further, the sub-housing 3 has a stepped structure 3c having a small cross-sectional area at the front and a large cross-sectional area at the back in a front end part (see FIG. 3A). In this stepped structure 3c, the sub-housing 3 is prevented from coming out through the optical connection opening 2d. The optical sub-connector S accommodated in the sub-connector accommodation space 2f is positioned in the main housing 2 and fixed at a predetermined position in the main housing 2 by setting the size and shape of the opening 2b, forming a locking structure between the locking inner projection 22 and the locking projecting portion 31 and providing a retaining structure in the front end part of the sub-housing 3.

On the other hand, the electrical connection terminals 7 are accommodated in the terminal accommodation space 2g in the main housing 2. The retainer member 20 constituting the main housing 2 is provided with a terminal locking piece 24 on the tip of an extending portion 23 extending forward up to a position corresponding to an intermediate part of the tubular portion 12 of the housing body portion 10. This terminal locking piece 24 can lock step structures 71 formed on the outer surfaces of the electrical connection terminals 7 accommodated in the terminal accommodation space 2g. The electrical connection terminals 7 accommodated in the terminal accommodation space 2g are positioned and fixed at predetermined positions in the main housing 2 by a locking structure between the terminal locking piece 24 of the retainer member 20 and the step structures 71 of the electrical connection terminals 7.

In manufacturing the composite connector 1 according to this embodiment, the optical ferrule 5 coupled to the optical cable 8 and the spring member 6 are accommodated into the sub-housing 3 to assemble the optical sub-connector S in advance. Then, the optical sub-connector S and the electrical connection terminals 7 coupled to the wires 9 are assembled into the main housing 2. In assembling into the main housing 2, the retainer member 20 is coupled to the housing body portion 10 after the optical sub-connector S and the electrical connection terminals 7 are respectively arranged in locations corresponding to the sub-connector accommodation space 2f and the terminal accommodation space 2g in the housing body portion 10. At this time, the locking inner projection 22 and the terminal locking piece 24 of the retainer member 20 may be respectively locked to the locking projecting portion 31 of the sub-housing 3 and the step structures 71 of the electrical connection terminals 7.

As just described, in the composite connector 1 according to this embodiment, the optical ferrule 5 is not directly fixed to the main housing 2, but the optical sub-connector S configured by accommodating the optical ferrule 5 into the sub-housing 3 is assembled into and fixed to the main housing 2 together with the electrical connection terminals 7. In this way, an optical communication part of the composite connector 1 is easily assembled. Normally, a manufacturing process and a manufacturing facility are largely different for optical connectors and electrical connectors and it is difficult to manufacture a connector including both an optical ferrule and electrical connection terminal(s) in the same manufacturing line. However, if the optical sub-connector S is assembled by accommodating the optical ferrule 5 into the sub-housing 3 and the optical ferrule 5 in the form of the optical sub-connector S is assembled into the main housing 2 as in this embodiment, the assembly of the optical sub-connector S can be performed independently of the assembly of an electrical connecting portion by applying the conventional manufacturing process and manufacturing facility for optical connectors. A step of assembling the thus assembled optical sub-connector S into the main housing 2 together with the electrical connection terminals 7 can be performed without great difficulty by applying the conventional manufacturing process and manufacturing facility for electrical connectors. Particularly, if the optical ferrule 5 has a small diameter for AGF, it tends to be difficult to handle the connector in the assembly process. However, if the optical sub-connector S is assembled in advance, difficulties due to a small diameter of the optical ferrule 5 hardly occur in the assembly process thereafter.

### <Structure of Optical Sub-Connector>

In the composite connector 1 according to this embodiment, the optical ferrule 5 is mounted in the form of the optical sub-connector S into the main housing 2 as described above. The configurations of this optical sub-connector S and the sub-housing 3 constituting the optical sub-connector S are described in detail. The configuration of the optical sub-connector S is shown in FIGS. 3A and 3B. FIG. 3B is a perspective view and FIG. 3B is a section along A-A in FIG. 3A.

The sub-housing 3 serving as an outer shell of the optical sub-connector S is configured as a resin member in the form of a hollow tube having openings on front and rear sides, and can accommodate at least one optical ferrule 5 connected to the optical cable 8 inside. The sub-housing 3 is composed of two divided members including an upper member 30 and a lower member 40. Out of those, the lower member 40 is a main member. The lower member 40 includes a tubular portion 41 at the front and an open portion 42 integrated with the tubular portion 41 and open upward behind the tubular portion 41. The upper member 30 is shaped to cover the open portion 42 of the lower member 40 from above, and the tubular sub-housing 3 is configured by coupling the upper member 30 to the open portion 42 of the lower member 40.

The lower member 40 includes a rear engaging piece 43 projecting upward in a rear end part of an upper end edge 44 of the smooth open portion 42 along the front-rear direction. A lock claw 431 is integrally formed on an upper end part of the rear engaging piece 43. The upper member 30 includes a rear engaging recess 32 in a rear end part of a smooth lower end edge 33 along the front-rear direction. The rear engaging recess 32 is formed as a dent capable of accommodating the rear engaging piece 43 and locking the lock claw 431. By coupling the upper and lower members 30, 40 and accommodating and engaging the rear engaging piece 43 into the rear engaging recess 32 with the lower end edge 33 of the upper member 30 and the upper end edge 44 of the lower member 40 butted against each other, the tubular sub-housing 3 is configured. In the sub-housing 3, a coupled state of the upper and lower members 30, 40 is maintained by engagement between the rear engaging piece 43 and the rear engaging recess 32. An engagement structure between the rear engaging piece 43 and the rear engaging recess 32 cannot be easily released once being engaged.

Further, the upper member 30 integrally includes a rib portion 34 projecting downward in an intermediate part in the front-rear direction of the lower end edge 33. The lower member 40 includes a rib accommodating portion 45 in an intermediate part in the front-rear direction of the upper end edge 44 of the lower member 40. The rib accommodating portion 45 is formed as a recess for accommodating the rib portion 34 projecting from the upper member 30, and can be engaged with the rib portion 34. The rib portion 34 is accommodated into the rib accommodating portion 45 to establish engagement when the upper and lower members 30, 40 are coupled with the lower end edge 33 of the upper member 30 and the upper end edge 44 of the lower member 40 butted against each other. The engagement of the rib portion 34 and the rib accommodating portion 45 assists the engagement of the rear engaging piece 43 and the rear engaging recess 32 to maintain the coupled state of the upper and lower members 30, 40 and suppresses the deformation of the sub-housing 3 as described later. In terms of enhancing functions of the rib portion 34 and the like, the rib portion 34 is preferably formed to take up a larger region in the front-rear direction than the rear engaging piece 43. Note that, unlike the rear engaging piece 43, the rib portion 34 is not provided with a locking claw structure, and the rib portion 34 and the rib accommodating portion 45 are engaged with the smooth end edge of the rib portion 34 projecting as a plate-like tab from the lower edge 33 of the upper member 30 held in contact with the smooth end edge of the rib accommodating portion 45 formed as a recess structure facing the upper end edge 44 of the lower member 40.

A cable holding portion 3b for holding the cable fixing member 82 is formed in a rear end part of the sub-housing 3. As the cable holding portion 3b, a depressed portion 35 serving as a semicylindrical recess capable of accommodating the small-diameter portion 842 of the cable fixing member 82 (crimp ring 84) is formed in a rear end part of the upper member 30. A window portion 36 serving as an opening, into which a part of an upper side of the large-diameter portion 841 of the cable fixing member 82 (crimp ring 84) is fittable, is provided in front of the depressed portion 35. In addition, a window portion 46, into which a part of a lower side of the large-diameter portion 841 of the cable fixing member 82 (crimp ring 84) is fittable, is also formed in a rear end part of the lower member 40, similarly to the window portion 36 of the upper member 30. These depressed portion 35 and two window portions 36, 46 constitute the cable holding portion 3b, and holds the optical cable 8 by the cable fixing member 82. That is, the optical ferrule 5 is coupled and the optical cable 8 mounted with the cable fixing member 82 is firmly held in the sub-housing 3 by the cable fixing member 82 by sandwiching the cable fixing member 82 between the upper and lower members 30, 40 with the cable fixing member 82 mounted on the optical cable 8 placed in the rear end part of the lower member 40, the depressed portion provided in the upper member 30 placed along the small-diameter portion 842 of the fixing member 82 and the large-diameter portion 841 fit in the window portions 36, 46.

In the optical sub-connector S, the optical ferrule 5 coupled to the optical cable 8 and the spring member 6 are accommodated inside the sub-housing 3 as shown in an exploded perspective view of FIG. 2 and a longitudinal section of FIG. 3B. In the sub-housing 3, a ferrule holding portion 47 is provided as a space tapered along the tapered shape of a flange portion 52 in the middle of the optical ferrule 5 inside the tubular portion 41 of the lower member 40. The optical ferrule 5 is positioned in the sub-housing 3 by the ferrule holding portion 47.

The spring member 6 constituted by a coil spring is arranged on a rear side of the optical ferrule 5. A front part of the spring member 6 is accommodated in the tubular portion 41 with a stretch axis oriented in the front-rear direction. A spring inserting portion 51 on the rear end of the optical ferrule 5 is inserted into a hollow part of the spring member 6 from front. The rear end of the spring member 6 comes into contact with a spring holding projection 37 projecting downward from the inside of the upper member 30 and is positioned. A distance between the rear end surface of the flange portion 52 of the optical ferrule 5 positioned by the ferrule holding portion 47 and the spring holding projection 37 is set to be shorter than a natural length of the spring member 6 in the sub-housing 3, and the spring member 6 is held in a compressed state between the flange portion 52 of the optical ferrule 5 and the spring holding projection 37 in the sub-housing 3. The spring member 6 pushes the optical ferrule 5 forward at the flange portion 52 by a restoring force generated by being compressed, thereby biasing the optical ferrule 5 forward. When the composite connector 1 is connected to the mating connector, the spring member 6 functions to bring the tip surface of the optical ferrule 5 into contact with the tip surface of the mating optical ferrule and further press the optical ferrule 5.

As just described, the composite connector 1 is easily assembled by arranging the spring member 6 capable of biasing the optical ferrule 5 toward the tip side together with the optical ferrule 5 in the sub-housing 3 in the optical sub-connector S. First, this is because, in assembling the optical sub-connector S, the optical ferrule 5 is easily held at a proper position and in a proper posture by being pushed toward the tip side in the sub-housing 3 and high manufacturability is obtained. Further, proper optical connection can be realized between the both optical ferrules by pressing the tip surface of the optical ferrule 5 in the sub-housing 3 against the tip surface of the mating optical ferrule by an effect of a biasing force of the spring member 6 when the composite connector 1 is connected to the mating connector even if slight errors occur in the position and posture of the optical ferrule 5 in the sub-housing 3 and the position and posture of the sub-housing 3 fixed in the main housing 2. Particularly, if an optical ferrule having a small diameter for AGF is used as the optical ferrule 5, it is difficult to arrange the optical ferrule 5 at a predetermined position and in a predetermined posture as compared to the case where an optical ferrule having a large diameter for POF is used. Thus, the above effects obtained by providing the spring member 6 are particularly high.

Further, the sub-housing 3 is divided into two members including the upper and lower members 30, 40, whereby the sub-housing 3 can be assembled to have a tubular shape after the optical ferrule 5 and the spring member 6 are arranged at correct positions in the sub-housing 3 and the assemblability of the optical sub-connector S is enhanced. For example, in assembling the sub-housing 3, the optical ferrule 5 and the spring member 6 may be placed in the lower member 40 with the spring inserting portion 51 of the optical ferrule 5 coupled to the optical cable 8 fit in the spring member 6. At this time, the optical ferrule 5 is positioned by the ferrule holding portion 47. Then, the upper member 30 may be arranged above the lower member 40 and the upper and lower members 30, 40 may be coupled to form the sub-housing 3, accompanied by the engagement between the rear engaging piece 43 and the rear engaging recess 32 and the engagement between the rib portion 34 and the rib accommodating portion 45. At this time, the cable fixing member 82 is vertically sandwiched by the cable holding portion 3b on the rear end of the sub-housing 3. Further, the spring member 6 is compressed by being pushed toward the flange portion 52 of the optical ferrule 5 by the spring holding projection 37 inside the upper member 30 while the upper member 30 is coupled to the lower member 40.

In the assembled optical sub-connector S, the optical ferrule 5 is biased forward by the compressed spring member 6, thereby being easily held at a proper position and in a proper posture in the sub-housing 3. In addition, since the cable fixing member 82 mounted on the optical cable 8 is fixed by the cable holding portion 3b, the optical ferrule 5 coupled to the optical cable 8 is easily held at the proper position and in the proper posture even if the optical cable 8 receives a tensile force. Thus, a concern for a position shift of the optical ferrule 5 due to the application of a tensile force to the optical cable 8 is reduced and the manufacturability and convenience during use of the photoelectric composite connector 1 are enhanced in a step of assembling the optical sub-connector S, a step of assembling the optical sub-connector S into the main housing 2 and during the use of the manufactured photoelectric composite connector 1.

Although the sub-housing 3 is composed of two divided members 30, 40 divided in the vertical direction here, a sub-housing may be composed of two divided members divided in the front-rear direction, i.e. a front member and a rear member. In that case, a cable holding portion for fixing and holding the cable fixing member 82 may be provided in a rear end part of the rear member. As in the case of vertical division, the optical ferrule 5 coupled to the optical cable 8 may be accommodated into the sub-housing configured by coupling the front and rear members with the optical ferrule 5 biased forward by the spring member 6 and the cable fixing member 82 fixed by the cable holding portion. An LC connector is known as an optical connector formed such that a housing is divided in the front-rear direction in this way. Also here, an optical sub-connector formed similarly to the LC connector may be applied.

### <Deformation Suppression of Sub-Housing by Rib Portion>

In the composite connector 1 according to this embodiment, the engagement structure of the rib portion 34 and the rib accommodating portion 45 is provided in the intermediate part in the front-rear direction of the sub-housing 3 constituting the optical sub-connector S as described above. This engagement structure suppresses the deformation of the sub-housing 3 in the optical sub-connector S.

In the optical sub-connector S, the spring member 6 is accommodated into the sub-housing 3 to bias the optical ferrule 5 forward. When the composite connector 1 is connected to the mating connector and this optical ferrule 5 is butted against the mating optical ferrule, the spring member 6 receives a pressing force from the mating optical ferrule and is compressed rearward. Then, a restoring force acting on the spring member 6 in the front-rear direction increases. The restoring force of the spring member 6 is transmitted to the sub-housing 3 via a coupled body of the optical ferrule 5 and the optical cable 8, mainly the cable fixing member 82, and acts as a force in a direction to push and expand the sub-housing 3 in the front-rear direction. Here, since the sub-housing 3 is formed by coupling the two divided members including the upper and lower members 30, 40 and a vertically divided state is not symmetrical in front and rear parts, i.e. the front part of the sub-housing 3 is constituted by the tubular portion 41 not divided in the vertical direction, whereas the rear part is vertically divided into the open portion 42 of the lower member 40 and the upper member 30, a force applied to the sub-housing 3 by the restoring force of the spring member 6 is not symmetrical in the front-rear direction. If a force asymmetrical in the front-rear direction is applied to the sub-housing 3, there is a possibility that the sub-housing 3 is deflected and deformed along the front-rear direction.

However, in this embodiment, the upper and lower divided members 30, 40 are provided with the rib portion 34 and the rib accommodating portion 45 in the intermediate part in the front-rear direction of the sub-housing 3, and the asymmetry in the front-rear direction of the force applied from the spring member 6 to the sub-housing 3 can be mitigated by engaging the both. This is because the force applied from the spring member 6 to the sub-housing 3 can be distributed between the upper and lower members 30, 40 via an engaging portion between the rib portion 34 and the rib accommodating portion 45. By mitigating the asymmetry of a force distribution, the deformation of the sub-housing 3 along the front-rear direction is suppressed.

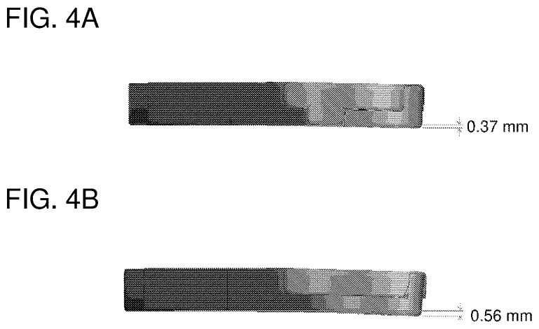

FIGS. 4A and 4B show simulation results of deformation occurring in the sub-housing 3 when the spring member 6 is compressed in the optical sub-connector S. A simulation was conducted by a stress analysis using a finite element method. FIGS. 4A and 4B are side views of the optical sub-connector S when viewed from outside in the width direction, a deformed outer shape is shown by a contour, and a deflection amount in the vertical direction at each position is shown by a color scale (see separately presented color images). Along with this, the deflection amount of the lower end of the rear end part deflected and deformed downward is indicated by a numerical value. The engaging portion composed of the rib portion 34 and the rib accommodating portion 45 is provided in the sub-housing 3 as shown in FIGS. 3A and 3B in FIG. 4A, and the smooth lower end edge 33 of the upper member 30 and the smooth upper end edge 44 of the lower member 40 are merely butted against each other without providing the rib portion 34 and the rib accommodating portion 45 in the sub-housing 3 in FIG. 4B.

According to FIGS. 4A and 4B, it is found that, in either form, the rear part (right side in figures) is deflected downward when the shape of the sub-housing 3 is viewed. It is also shown by the color scales that the deflection amount increases toward the rear. However, the rear part is less deflected and deformed in the form of FIG. 4A provided with the rib portion 34 than in the form of FIG. 4B not provided with the rib portion 34, and the deflection amount of the rear end indicated by the numerical value is suppressed to 70% or less in the case of FIG. 4A than in the case of FIG. 4B. Further, according to the color scales, a region with a large deflection amount is concentrated in a very narrow region of the rear end part of the lower member 40 along the front-rear direction in FIG. 4B, whereas the concentration of deflection in the rear end part of the lower member 40 is mitigated in FIG. 4A. More specifically, a difference in the distribution of the deflection amount between the lower and upper members 40, 30 decreases and the deflection amount is distributed to gently change along the front-rear direction.

From these simulation results, it is found that the deformation along the front-rear direction of the sub-housing 3 associated with the compression of the spring member 6 is suppressed by providing the rib portion 34 and the rib accommodating portion 45 in the intermediate part in the front-rear direction of a coupled location between the upper and lower members 30, 40 of the sub-housing 3 and forming the engagement structure of those. This is interpreted to be because a force applied in an expansion direction to the sub-housing 3 from the compressed spring member 6 is distributed between the upper and lower members 30, 40 and along the front-rear direction by the engagement structure of the rib portion 34 and the rib accommodating portion 45.

As the rib portion 34 and the rib accommodating portion 45 are formed to take up a larger region, the deflection and deformation of the sub-housing 3 is thought to be more effectively suppressed in the optical sub-connector S. However, if the rib portion 34 is formed to be excessively large, the optical sub-connector S is enlarged, leading to the enlargement of the entire composite connector 1, which is not preferable. Further, if the sub-housing 3 is provided with the large rib portion 34, the engaging portion composed of the rib portion 34 and the rib accommodating portion 45 tends to project outward as compared to the surroundings. Such a structure possibly obstructs an operation in the steps of assembling the optical sub-connector S and assembling the optical sub-connector S into the main housing 2 and impairs the manufacturability of the composite connector 1.

To void those situations, the shapes of the rib portion 34 and the rib accommodating portion 45 are set such that the engaging portion composed of the rib portion 34 and the rib accommodating portion 45 is not enlarged and does not project. Specifically, the rib portion 34 extends from the lower end edge 33 while being flush with a side surface 38 of the upper member 30. The rib accommodating portion 45 is provided as a recess structure by cutting a part of an outer thickness side downward from the upper end edge 44 in a side surface 48 of the lower member 40. By forming the rib portion 34 and the rib accommodating portion 45 to have such simple shapes, the engaging portion obtained by engaging the rib portion 34 and the rib accommodating portion 45 does not protrude outward, i.e. in the vertical direction and width direction, about a center axis of the sub-housing 3 (coinciding with a center axis of the optical ferrule 5 in the shown embodiment) along the front-rear direction as compared to other parts when the upper and lower members 30, 40 are coupled and the rib portion 34 and the rib accommodating portion 45 are engaged. Further, the engaging portion is flush with locations before and after the engaging portion on the outer peripheral surface (side surfaces 38, 48) of the sub-housing 3. By adopting such a configuration, a rear part formed from the open portion 42 of the lower member 40 and the upper member 30 has a shape, which can be approximated to a simple rectangular tube, in the sub-housing 3, and the sub-housing 3 includes neither a locally enlarged part nor a projecting part. As a result, the miniaturization of the optical sub-connector S and the entire composite connector 1 is achieved and the simplification of the steps of assembling and mounting the optical sub-connector S is promoted.

### OTHER EMBODIMENTS

Although the upper member 30 of the sub-housing 3 is provided with the rib portion 34 and the lower member 40 is provided with the rib accommodating portion 45 in the above embodiment, a rib portion and a rib accommodating portion may be reversed. That is, a rib portion projecting toward the other end edge may be formed in an intermediate part in the front-rear direction of one end edge, out of two end edges including the lower end edge 33 of the upper member 30 and the upper end edge 44 of the lower member 40. A rib accommodating portion may be provided as a recess capable of accommodating the rib portion and being engaged with the rib portion in an intermediate part in the front-rear direction of the other end edge.

Further, as described above, the type and number of the electrical connection terminals 7 are not particularly limited. For example, either ordinary terminals not supposed to comply with specific standards or terminals satisfying predetermined standards such as Ethernet (registered trademark) standards may be used as the electrical connection terminals 7. The use of ordinary terminals is better due to low cost and the use of terminals satisfying predetermined standards is better in being able to ensure performances of the electrical connecting portions such as communication performance.

In the case of providing a plurality of the electrical connection terminals 7, an arrangement direction of those electrical connection terminals 7 is also not particularly limited. In the above embodiment, the pair of electrical connection terminals 7 are arranged in the vertical direction (c direction) together with the sub-housing 3 accommodating the optical ferrule 5 (hereinafter, referred to as “series arrangement”) as shown. However, for example, the pair of electrical connection terminals 7 arranged in the width direction (b direction) and the sub-housing 3 accommodating the optical ferrule 5 may be arranged in the vertical direction (c direction) (hereinafter, referred to as “parallel arrangement”). Which of the series arrangement and the parallel arrangement should be adopted may be selected according to the use application of the composite connector 1, the type of the electrical connection terminals 7 and the like. Further, the composite connector according to this embodiment is a cable connector and the series arrangement or the parallel arrangement may be selected in accordance with the arrangement of electrical connecting portions and an optical connecting portion of a mating connector to be connected such as a board connector (PCB connector). However, the parallel arrangement is better in space saving since the entire composite connector 1 is easily set to have a small size.

Further, although waterproofness is not given to the composite connector 1 in the above embodiment, the composite connector 1 may be configured as a waterproof connector. For example, it is considered to close the rear end opening of the main housing 2 including the sub-connector accommodation space 2f and the terminal accommodation space 2g by a waterproof plug.

The present invention is not limited at all by the above embodiment and various modifications can be made without departing from the gist of the present invention.

### LIST OF REFERENCE NUMERALS

1 (photoelectric) composite connector
2 main housing
2a partition wall
2b opening on rear end of sub-connector accommodation space
2c front end surface
2d optical connection opening
2e electrical connection opening
2f sub-connector accommodation space
2g terminal accommodation space
3 sub-housing
3a connection sub-opening
3b cable holding portion
3c stepped structure
5 optical ferrule
6 spring member
7 electrical connection terminal
8 optical cable
9 (insulated) wire
10 housing body portion
12 tubular portion
13 open portion
14 locking projection
15 claw
20 retainer member
21 locking tab
22 locking inner projection
23 extending portion
24 terminal locking piece
30 upper member
31 locking projecting portion
32 rear engaging recess
33 lower end edge
34 rib portion
35 depressed portion
36 window portion
37 spring holding projection
38 side surface
40 lower member
41 tubular portion
42 open portion
43 rear engaging piece
431 lock claw
44 upper end edge
45 rib accommodating portion
46 window portion
47 ferrule holding portion
48 side surface
51 spring inserting portion of optical ferrule
52 flange portion of optical ferrule
71 step structure of electrical connection terminal
81 optical fiber
82 cable fixing member
83 stop ring
84 crimp ring
841 large-diameter portion
842 small-diameter portion
a front-rear direction
b width direction
c vertical direction
S optical sub-connector

1. A photoelectric composite connector, comprising:
at least one optical ferrule to be coupled to an optical fiber of an optical cable;
at least one electrical connection terminal to be coupled to a wire;
a sub-housing for accommodating the at least one optical ferrule;
a spring member for biasing the optical ferrule toward a tip side by being accommodated into the sub-housing; and
a main housing capable of collectively accommodating the sub-housing and the electrical connection terminal,
the sub-housing constituting an optical sub-connector by accommodating the optical ferrule and the spring member,
the main housing accommodating and fixing the optical sub-connector and the electrical connection terminal,
the sub-housing being composed of two divided members including an upper member and a lower member divided in a vertical direction orthogonal to a front-rear direction along an axis of the accommodated optical ferrule,
the sub-housing including a cable holding portion for sandwiching and fixing a cable fixing member mounted on the optical cable coupled to the optical ferrule between the two divided members in a rear end part,
the optical ferrule coupled to the optical cable being accommodated in the sub-housing with the optical ferrule biased forward by the spring member and the cable fixing member sandwiched by the cable holding portion in the optical sub-connector,
the upper and lower members being coupled with two end edges including a lower end edge along the front-rear direction of the upper member and an upper end edge along the front-rear direction of the lower member butted against each other in the sub-housing,
one of the two end edges including a rib portion projecting toward the other end edge in an intermediate part in the front-rear direction,
the other end edge including a rib accommodating portion in an intermediate part in the front-rear direction, the rib accommodating portion being in the form of a recess for accommodating the rib portion and engaging the rib portion,
the rib portion projecting as a plate-like tab from the one end edge, the rib portion having a smooth end edge without including a claw-like structure,
the rib accommodating portion being formed as a recess structure facing the other end edge, the rib accommodating portion having a smooth end edge,
the rib portion and the rib accommodating portion being engaged with the smooth end edge of the rib portion held in contact with the smooth end edge of the rib accommodating portion in a state where the upper and lower members are coupled to each other.

2. The photoelectric composite connector according to claim 1, wherein the spring member presses a tip surface of the optical ferrule constituting the optical sub-connector toward a tip surface of an optical ferrule of a mating connector when the photoelectric composite connector is connected to the mating connector including the optical ferrule.

3. The photoelectric composite connector according to claim 1, wherein an engaging portion obtained by engaging the rib portion and the rib accommodating portion does not protrude outward about a center axis along the front-rear direction as compared to other parts with the upper and lower members coupled to each other in the sub-housing.

4. The photoelectric composite connector according to claim 3, wherein an outer peripheral surface of the sub-housing is flush with the engaging portion obtained by engaging the rib portion and the rib accommodating portion and locations before and after the engaging portion with the upper and lower members coupled to each other.

5. The photoelectric composite connector according to claim 1, wherein one of the upper and lower members is provided with a rear engaging piece integrally formed with a lock claw in a rear end part and the other is provided with a rear engaging recess as a recess capable of accommodating the rear engaging piece and locking the lock claw.

6. The photoelectric composite connector according to claim 5, wherein the rib portion takes up a larger region in the front-rear direction than the rear engaging piece.

7. (canceled)
